(19) United States
(12) Patent Application Publication
(10) Pub. No.: US 2021/0011042 A1
(43) Pub. Date: Jan. 14, 2021

(54) INTEGRATED CARTRIDGE SERVICE STATION

(71) Applicant: HEWLETT-PACKARD DEVELOPMENT COMPANY, L.P., SPRING, TX (US)

(72) Inventors: Craig Olbrich, Corvallis, OR (US); Heather B. Louderback, Corvallis, OR (US); Christie Dudenhoefer, Corvallis, OR (US); Dennis R. Esterberg, Corvallis, OR (US)

(73) Assignee: HEWLETT-PACKARD DEVELOPMENT COMPNANY, L.P., SPRING, TX (US)

(21) Appl. No.: 16/500,066

(22) PCT Filed: Jul. 18, 2017
(86) PCT No.: PCT/US2017/042539

§ 371 Date: Oct. 1, 2019

(51) Int. Cl. G01N 35/10

(52) U.S. Cl. CPC G01N 35/1002; B08B 1/02; G01N 35/1004

(57) ABSTRACT

An integrated cartridge service station may include a reagent module comprising at least one reagent ejection device, and a service module integrated with the reagent module. The service module may include at least one service device. The reagent module and the service module are movable with respect to one another within a reagent dispensing system. The at least one reagent ejection device is movable between an in-line position and an off-line position within the reagent dispensing system.

### BACKGROUND

The life sciences research and associated diagnostic industries use a number of reagents and patient samples to perform testing and diagnostics. Dispensing liquids such as these reagents and patient samples in quantities from picoliters to microliters may be used in many areas of pharmaceutical and biology research. For example, dispensing a number of reagents in these quantities may be useful in medical and veterinary diagnostics, forensics testing, and agricultural testing to determine the presence of a chemical or biological in a sample. Even within these fields, low-volume liquid dispensing may be used for many different operations.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a reagent dispensing system, according to an example of the principles described herein.

FIG. 2 is a block diagram of an integrated cartridge service station, according to an example of the principles described herein.

FIG. 3 is a block diagram of a computer program product for servicing a reagent dispensing device, according to an example of the principles described herein.

FIG. 4 is a block diagram of a reagent dispensing system, according to another example of the principles described herein.

FIG. 5 is a block diagram of a reagent module, according to an example of the principles described herein.

FIG. 6 is a diagram of an integrated cartridge service station, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Human interaction during life science research and diagnostic processes may lead to mistakes in those processes. Such mistakes may decrease the likelihood of scientific breakthroughs and increase the likelihood of misdiagnosis of patients illnesses. Further, with human interaction, these processes may prove tedious thereby increasing the costs associated with these processes as well as increase the time spent completing the processes. Automation of these processes, however, limits mistakes, time, and costs.

Instruments and tools used in life science research and diagnostic processes have been developed to increase efficiency, decrease costs, and decrease time spent conducting this research or completing diagnosis. However, even with these developments, increased numbers of reagents used to interact with a sample increase the complexity and time of completing those tasks.

In an automated, computer-driven diagnostics system, reagents may be dispensed based on a number of test protocols, and a wide variety and volumes of different reagents may be dispensed based on these test protocols. Some reagents may cause a dispensing device such as a die-based reagent dispensing device or a reagent dispensing device with nozzles to clog or become obstructed. A number of service devices such as spittoons, wipers, and capping modules maybe used to increase or maintain the health of the reagent dispensing devices. However, in order to service the reagent dispensing devices, the reagent dispensing devices may be taken off-line and presented to these service modules for servicing. This may cause the reagent dispensing system to take more time to dispense reagent.

Examples described herein provide a reagent dispensing system. The reagent dispensing system may include at least one reagent module including at least one reagent dispensing device to dispense a number of reagents on a substrate, a module frame electrically and mechanically coupling the reagent dispensing device to the reagent dispersing system, a service module integrated with the at least one reagent ejection device, the service module comprising at least one service device. In one example, the at least one reagent ejection device and the integrated service module are movable with respect to one another. In this example, the reagent module is movable between an in-line position and an off-line position within the reagent dispensing system. In another example, the at least one reagent ejection device and the integrated service module are movable from an in-line position to an off-line position within the service system. In this example, the reagent module and its reagent ejection devices is movable with the service module between the in-line position and the off-line position within the reagent dispensing system.

The at least one service device may include a capping module to seal a number of nozzles of the at least one reagent ejection device from ambient atmosphere, a wiping module to wipe a nozzle plate of the at least one reagent ejection device, a spittoon to receive spat reagent from the at least one reagent ejection device, or combinations thereof. The at least one reagent ejection device may include a plurality of reagent ejection device. The module frame couples the plurality of reagent ejection devices to one another, the coupled reagent ejection devices and module frame forming the reagent module. The service module services each of the reagent ejection devices within the reagent module. The service module may service the at least one reagent dispensing device at an on-line position, at an off-line position, or a combination thereof. The reagent ejection devices may be grouped within the reagent module based on a probability of cross-contamination between the plurality of the reagent ejection devices, an expiration date of the reagents within the reagent dispensing cartridges, a frequency of use of the reagents within the reagent dispensing cartridges, a volume of use of the reagents within the reagent dispensing cartridges, or combinations thereof. The at least one reagent ejection device may include a plurality of reagent ejection devices, and the service module may include a plurality of service modules. In this example, each of the reagent ejection devices may be integrated with a respective one of the plurality of service modules.

Examples described herein provide an integrated cartridge service station. The integrated cartridge service station may include a reagent module comprising at least one reagent ejection device, and a service module integrated with the reagent module. The service module may include at least one service device. The reagent module and the service module are movable with respect to one another within a reagent dispensing system. Further, the at least one reagent ejection device is movable between an in-line position and an off-line position within the reagent dispensing system.

The at least one service device may include a capping module to seal a number of nozzles of the at least one reagent ejection device from ambient atmosphere, a wiping module to wipe a nozzle plate of the at least one reagent ejection device, a spittoon to receive spat reagent from the at least one reagent ejection device, or combinations thereof. The spittoon may include a disposable absorbent material. The wiping module and the spitting module may include a disposable absorbent material.

Examples described herein provide a computer program product for servicing a reagent dispensing device. The computer program product may include a computer readable storage medium including computer usable program code embodied therewith. The computer usable program code, when executed by a processor, identifies a service parameter of at least one reagent dispensing device within a reagent dispensing system. Further, the computer usable program code, when executed by the processor, initiates a servicing process of the reagent dispensing device using a service module integrated with the at least one reagent dispensing device in response to the service parameter being met. The service module moves relative to the at least one reagent ejection device during the servicing process.

The at least one reagent dispensing device may include a plurality of reagent dispensing devices. The plurality of the reagent ejection devices may be integrated with the service module. Further, initiating the servicing process may include servicing a plurality of the reagent ejection devices integrated with the service module. The integrated service module may include a capping device, a wiping device, a spittoon device, or combinations thereof.

As used in the present specification and in the appended claims, the term “a number of” or similar language is meant to be understood broadly as any positive number comprising 1 to infinity: zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may or may not be included in other examples.

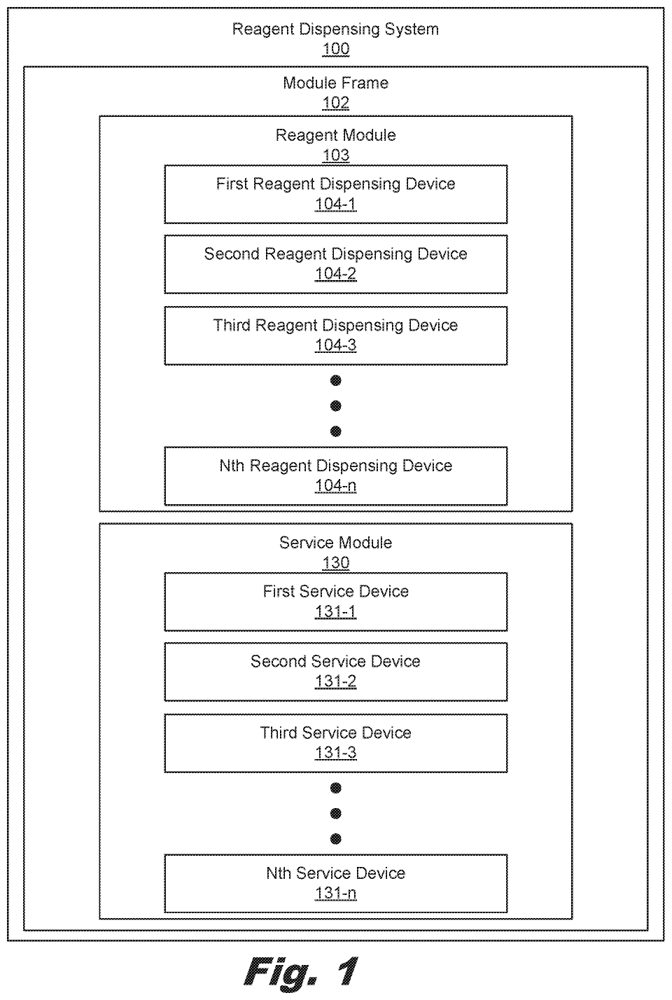

Turning now to the figures, FIG. 1 is a block diagram of a reagent dispensing system (100), according to an example of the principles described herein. The reagent dispensing system (100) may be any system that dispenses a reagent onto a substrate. In one example, the reagent dispensing system (100) is an automated, computer driven system that dispenses, through a number of reagent dispensing devices, a number of different reagents. The reagents may be any chemical or biological substance that may be used in any chemical reaction such as titrations, combinations, decompositions, single displacements, precipitations, neutralizations, double displacements, combustions, and reductions/oxidations, among other types of chemical or biological reactions. The reagents may be, for example, solutions including nucleic acid; deoxyribonucleic acid (DNA); ribonucleic acid (RNA); small (or short) interfering RNA (siRNA); polymerase chain reaction (FOR) master mix; proteins including, for example, enzymes and antibodies; other biomolecules including, for example, peptides, oligos, and lipids; small molecules, nanoparticles, biocides, cells or other tissue components, histology stains, linker reagents, inhibitors, aqueous solutions, or many other reagents.

In one example, the reagents may be dispensed on a number of substrates that are present on a conveyance system. In this example, the conveyance system may be any system on which a number of substrates are conveyed underneath a reagent module (103) located at an in-line position of the reagent dispensing system (100). In one example, the substrates may be microscope slides, test samples, cell-culture dishes such as Petri dishes, paper, tissue samples, porous media, lateral flow strip media, coated media, microtiter plates, or other substrates. At the in-line position, the reagent dispensing devices (104) of the reagent module (103) may dispense their respective reagents onto the substrates.

In one example, the reagent module (103) may be exchanged for another reagent module (103). In this example, a number of reagent modules (103) may be located off-line with respect to the in-line position of the conveyance system, and may contain reagents within their respective reagent dispensing devices (104) that differ from those in the reagent modules (103) located at the in-line position. In one example, the reagent modules (103) positioned at the in-line position may be exchanged by hand by, for example, a technician overseeing the processes performed by the reagent dispensing system (100). In another example, the reagent modules (103) positioned at the in-line position may be exchanged using an automated system that utilizes tracks, robotic devices, carousels, conveyor systems, other transport systems, or combinations thereof to exchange an in-line reagent module (103) with an off-line reagent module (103).

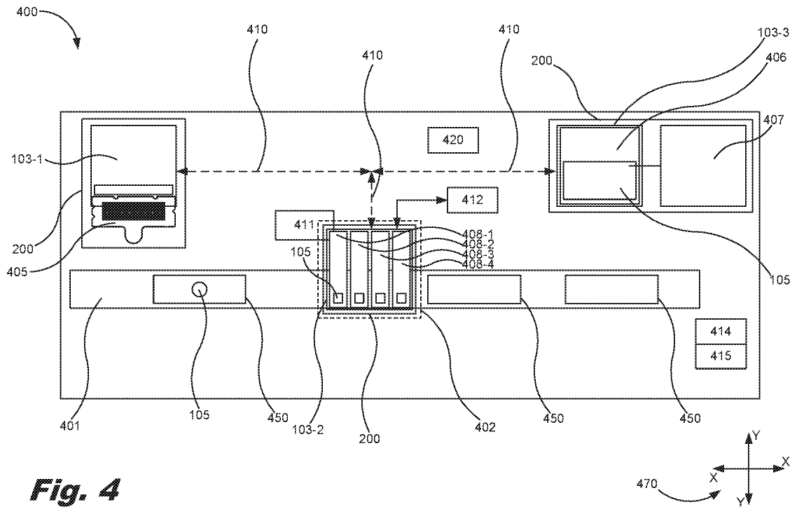

The reagent module (103) may include a module frame (102) to mechanically and electrically couple the reagent dispensing devices (104) within the reagent module (103) to the reagent dispensing system (100). The module frame (102) may include a number of mechanical interfaces to align the reagent dispensing devices (104) with respect to the reagent module (103). Further, the module frame may include a number of electrical interfaces to electrically couple the reagent dispensing devices (104) to the reagent module (103), and, in turn, the reagent dispensing system (100), Signals may be sent by the reagent dispensing system (100) to the reagent dispensing devices (104) via the number of electrical interfaces of the reagent module (103). These signals may be used to instruct the reagent dispensing devices (104) to disperse a volume of reagent onto a substrate located on the dispersion surface (FIG. 4, 401).

Each of the reagent dispensing devices (104) may be any device that dispenses a number of reagents. In one example, the reagent dispensing devices (104) may include devices that dispense different volumes of reagents. For example, a first reagent dispensing device (104-1) may dispense a first range of volumes of a reagent, a second reagent dispensing device (104-2) to dispense a second range of volumes of a reagent where the second range of volumes may be more voluminous relative to the first range of volumes, and a third reagent dispensing device (104-3) to dispense a third range of volumes of a third reagent where the third range of volumes may be more voluminous relative to the second range of volumes.

As depicted using the ellipses in FIG. 1 and the inclusion of an Nth reagent dispensing device (104-n), any number of reagent dispensing devices may be included within a reagent module (103). Each of these reagent dispensing devices (104-1, 104-2, 104-3, 104-n, collectively referred to herein as 104) may have differing architectures or form factors that allow them to dispense their respective volumes. For example, the first reagent dispensing device (104-1) may include a cassette device that dispenses between approximately 1 picoliter (pL) and 10 microliters (μL) as the first range of volumes of a reagent. The cassette may include, for example, a T8+ or D4+ dispensehead cassette produced and distributed by HP, Inc. With these types of cassettes, a relatively small amount of reagent may be dispensed at a given time. In one example, the first reagent dispensing device (104-1) or cassette may be any digitally addressable fluid ejection device that contains a very small amount of reagent on the order of approximately up to 1 milliliter (mL). Further, the fluid within the first reagent dispensing device (104-1) may come pre-filled in the first reagent dispensing device (104-1), or a technician may fill the first reagent dispensing device (104-1) with a pipette or similar preliminary, manual reagent dispensing device at the time of use of the first reagent dispensing device (104-1).

Further, in one example, the second reagent dispensing device (104-2) may include a digitally addressable fluid ejection device. In this example, the digitally addressable fluid ejection device may include a number of fluid ejection die to dispense the second range of volumes of a reagent. For example, the second reagent dispensing device (104-2) may include a digitally addressable fluid ejection device that dispenses between approximately 100 nanoliters (nL) and 100 μL as the second range of volumes of a reagent. In one example, the digitally addressable fluid ejection device may be a thermal or piezoelectric fluid ejection device where the reagents are dispensed from an array of fluid ejection chambers and nozzles of the fluid ejection die using thermal expansion or piezoelectric forces applied to the reagents. In this example, the second reagent dispensing device (104-2) may contain, for example, 1 to 40 milliliters of reagent and may be pre-packaged with the reagent before the time of use.

Still further, in one example, the third reagent dispensing device (104-3) may include any high-volume reagent dispensing device such as, for example, a digitally addressable fluid ejection device fluidically coupled to an off-line bulk supply of reagent. In this example, the third reagent dispensing device (104-3) may be used in connection with the dispensing of bulk amounts of reagents. The third reagent dispensing device (104-3) may include a digitally addressable fluid ejection device that dispenses between approximately 100 nanoliters (nL) and 100 μL as the third range of volumes of a reagent. In this example, the third reagent dispensing device (104-3) may contain bulk volumes of reagent since this bulk reagent dispensing device may be used most often, Thus, third reagent dispensing device (104-3) may contain for example, 40 to 1,000 mL of reagent and may be pre-packaged with the reagent before the time of use.

With regard to the reagent dispensing devices (104-1, 104-2, 104-3, 104-n), a frequency of use and amount of dispersion of respective reagents within a given time period may be taken into consideration in determining what reagents are placed in what type of architecture of reagent dispensing devices (104-1, 104-2, 104-3, 104-n). For example, for reagents that are utilized relatively more often and/or at higher dispensed volumes, the third reagent dispensing device (104-3) may be used. In this example, the third reagent dispensing device (104-3) may contain reagents used daily, with dispense volumes ranging from approximately 100 nL and 100 μL. In one example, the third reagent dispensing device (104-3) may be fluidically coupled to the off-line bulk supply of reagent to allow for larger volumes of its reagent to be made available to the third reagent dispensing device (104-3).

Further, for reagents that are utilized relatively less often and/or at lower dispensed volumes relative to the third reagent dispensing device (104-3), the second reagent dispensing device (104-2) may be used. In this example, the second reagent dispensing device (104-2) may contain reagents used regularly with dispense volumes met by a fill volume of the second reagent dispensing device (104-2). The second reagent dispensing device (104-2) may be utilized for reagents used weekly to daily, with dispense volumes ranging from approximately 0.5 mL to 20 mL per month.

Still further, for reagents that are utilized relatively less often and/or at lower dispensed volumes relative to the second and third reagent dispensing device (104-2, 104-3), the first reagent dispensing device (104-1) may be used. In this example, the first reagent dispensing device (104-1) may contain reagents used intermittently or rarely with low dispense volumes of the reagent. The first reagent dispensing device (104-1) may be utilized less often than weekly, and for dispense volumes ranging from approximately 10 μL to 0.5 mL per month.

In this manner, the types of architectures had by the reagent dispensing devices (104-1, 104-2, 104-3, 104-n) may be individually utilized based on their dispensing volumes, their capacities, and their frequency of use. A reagent dispensing system (100) that permits for multiple architectural types of reagent dispensing devices (104-1, 104-2, 104-3, 104-n) provides for efficient management and use of reagents that vary widely in terms of their dispensing environmental conditions and their usage rate. Further, the dispensing of reagents in the manner provided by the reagent dispensing devices (104-1, 104-2, 104-3, 104-n) provides a more effective level of control as to amounts of reagents dispensed, and is easier to use relative to, for example, pipette-based methods of reagent dispensing. Further, the reagent dispensing devices (104-1, 104-2, 104-3, 104-n) allow for a more precise placement of reagents on a substrate, including onto specific regions of a tissue sample, for example. Still further, reagents dispensed by the reagent dispensing devices (104-1, 104-2, 104-3, 104-n) may be used with significantly improved efficiency since less reagents are wasted during dispensing. In one example, this increased in efficiency may be as high as 1,000 time more efficient. Even still further, the reagent dispensing devices (104-1, 104-2, 104-3, 104-n) easily combine reagents on the substrate in a digitally addressed manner such that, for example, multiple reagents may be dispensed next to one another or at the same location, as desired.

In one example, each reagent module (103) may include a single reagent dispensing device (104-1, 104-2, 104-3, 104-n), and, in this example, a number of reagent modules (103) may be exchanged with one another to an in-line position relative to the dispersion surface (FIG. 4, 401), or exist in a number of stations in-line with the dispersion surface (FIG. 4, 401). The reagent modules (103), in this example, may dispense with their respective single reagent dispensing devices (104-1, 104-2, 104-3, 104-n), their respective volumes. Provisioning of a single reagent dispensing device (104-1, 104-2, 104-3, 104-n) within a reagent module (103) assists in ensuring that the reagents within the reagent dispensing devices (104-1, 104-2, 104-3, 104-n) are not cross-contaminated or cause an unexpected reaction off-line if they were grouped as a plurality of reagent dispensing devices (104-1, 104-2, 104-3, 104-n) within a reagent module (103). In another example, a plurality of the reagent dispensing devices (104-1, 104-2, 104-3, 104-n) may be grouped in a reagent module (103) based on the reagents contained in the reagent dispensing devices (104-1, 104-2, 104-3, 104-n) not having an affinity to react with one another or cross-contaminate one another. In one example, the reagent ejection devices (104) may be grouped within the reagent module (103) based on a probability of cross-contamination between the plurality of the reagent ejection devices (104), an expiration date of the reagents within the reagent dispensing cartridges (104), a frequency of use of the reagents within the reagent dispensing cartridges (104), a volume of use of the reagents within the reagent dispensing cartridges (104), or combinations thereof.

The reagent dispensing system (100) may also include a service module (130). In one example, the service module (130) may be integrated with the at least one reagent ejection device (104), the reagent module (103), the module frame (102), or combinations thereof. Integration with the reagent ejection device (104), the reagent module (103), the module frame (102) or combinations thereof allows the service module (130) to remain with these elements so that servicing of the reagent ejection devices (104) of the reagent module (103) may be performed at any time or position including before deposition of a number of reagents, after deposition of a number of reagents, while the reagent module (103) is in an in-line position, while the reagent module (103) is in an off-line position, other times or positions, or combinations thereof.

In one example, the at least one reagent ejection device (104) and the integrated service module (130) may be movable from an in-line position to an off-line position within the reagent dispensing system (100). In this example, the service module, due to it being integrated with the reagent ejection device (104), the reagent module (103), the module frame (102), or combinations thereof, may be movable with these elements of the reagent dispensing system (100) between the in-line position and the off-line position within the reagent dispensing system (100).

The service module (130) may include a number of service devices (131-1, 131-2, 131-3, 131-n, collectively referred to herein as 131). The service devices (131) may be any device that, through interaction with the reagent dispensing devices (104) increases the operability of the reagent dispensing devices (104), maintains the operability of the reagent dispensing devices (104), or otherwise reduces errors in the operation of the reagent dispensing devices (104). In one example, the service devices (130) may be a capping module to selectively seal a number of reagent ejection nozzles of the reagent ejection devices (104) from ambient atmosphere, a wiping module to wipe a nozzle plate of the reagent ejection devices (104), a spittoon to receive spat reagent from the reagent ejection devices (104), other devices that service the reagent ejection devices (104), or combinations thereof.

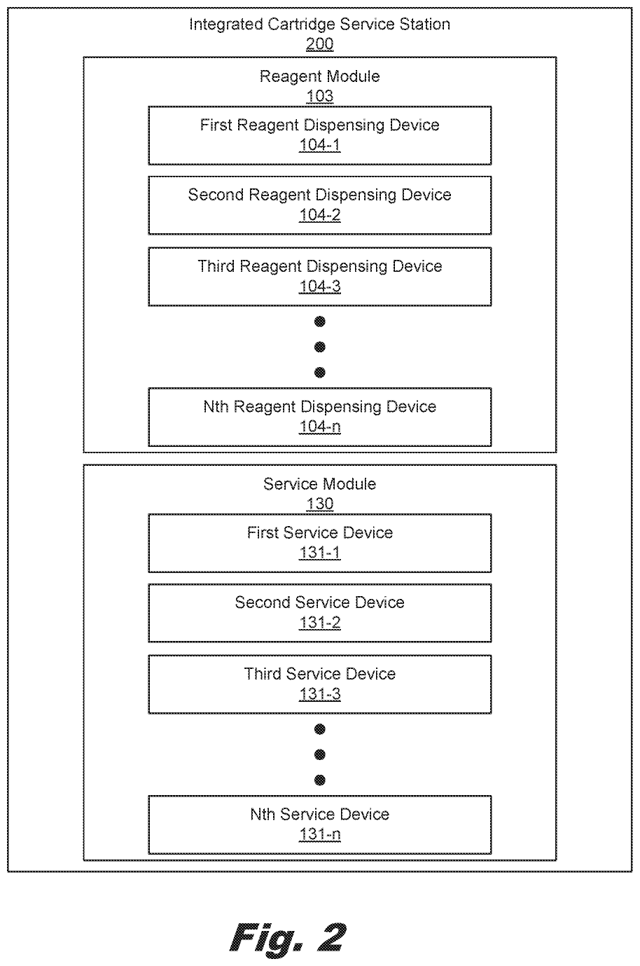

FIG. 2 is a block diagram of an integrated cartridge service station (200), according to an example of the principles described herein. The integrated cartridge service station (200) may include a number of elements including the reagent module (103), the service module (130), and their respective elements described in connection with FIG. 1. Therefore, similarly-numbered elements included in FIG. 1 and described in connection with FIG. 1 designate similar elements within the integrated cartridge service station (200) of FIG. 2. The integrated cartridge service station (200) may include a reagent module (103) including at least one reagent ejection device (104), A service module (130) integrated with the reagent module (103) may also be included in order to service the reagent ejection devices (104) included in the reagent module (103). The service module (130) includes at least one service device. Further, in one example, the service module (130) is movable from an in-line position to an off-line position within a reagent dispensing system (100) as the reagent ejection devices (104) and reagent module (103) move between the in-line position and the off-line position within the reagent dispensing system (100).

In another example, the service module (130) may be stationary and continually located at an off-line position or in-line position so that the reagent module (103) or its reagent ejection devices (104) move in and out of the service module (130) or in and out of a coupling or interfacing state relative to the service module (130), For example, the service module (130) may be located at an in-line position, and the reagent module (103) or its reagent ejection devices (104) move into a coupling state with the service module (130) as the reagent module (103) or its reagent ejection devices (104) move into the in-line position. In another example, the service module (130) may be located at an off-line position, and the reagent module (103) or its reagent ejection devices (104) move into a coupling state with the service module (130) as the reagent module (103) or its reagent ejection devices (104) move into the off-line position.

In another example, the service module (130) may move to the position of the reagent module (103) or its reagent ejection devices (104). In this example, the reagent module (103) or its reagent ejection devices (104) may be located at an in-line position or an off-line position. In either position, the service module (130) may move to and couple with the reagent module (103) or its reagent ejection devices (104) at these in-line or off-line positions.

The service devices (131) of the integrated cartridge service station (200) may include a capping module to seal a number of nozzles of the reagent ejection devices (104) from ambient atmosphere, a wiping module to wipe a nozzle plate of the at least one reagent ejection device (104), a spittoon to receive spat reagent from the reagent ejection devices (104), or combinations thereof. Further, in one example, the spittoon of the integrated cartridge service station (200) may include a disposable absorbent material. Further, in one example, the wiping module and the spitting module of the integrated cartridge service station (200) may include a disposable absorbent material. In this example, the wiping module and the spitting module of the integrated cartridge service station (200) may be embodied as a single element. In another example, the wiping module and the spitting module of the integrated cartridge service station (200) may be separate elements that each include a disposable absorbent material.

The reagent module (103) may include any number of reagent dispensing devices (104-1, 104-2, 104-3, 104-n). In one example, four reagent dispensing devices (104-1, 104-2, 104-3, 104-n) may be included in the reagent module (103) as depicted in FIG. 2. However, as depicted using the ellipses in FIG. 2 and the inclusion of an Nth reagent dispensing device (104-n), any number of reagent dispensing devices (104) may be included within a reagent module (103). Each of the reagent dispensing devices (104-1, 104-2, 104-3, 104-n) may include a volume of reagent. In one example, the reagents within each of the reagent dispensing devices (104-1, 104-2, 104-3, 104-n) may be different. However, in other examples, at least two of the reagent dispensing devices (104-1, 104-2, 104-3, 104-n) among the plurality of reagent dispensing devices (104-1, 104-2, 104-3, 104-n) within the reagent module (103) may dispense an identical or substantially similar reagent.

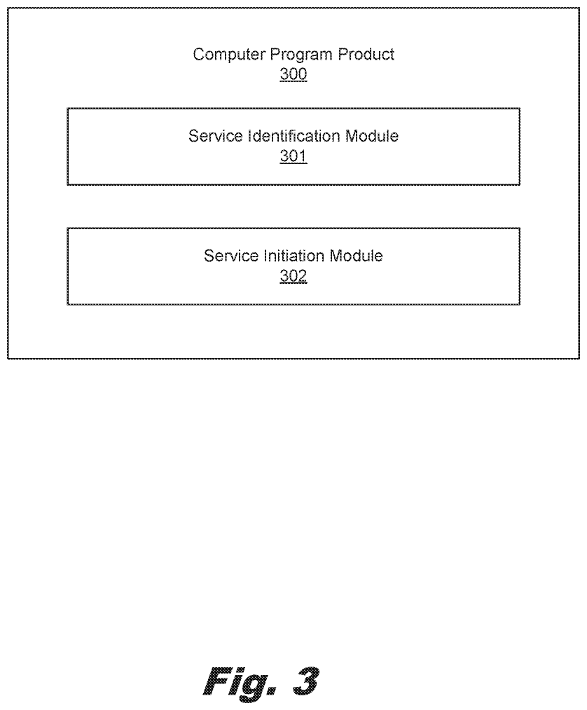

FIG. 3 is a block diagram of a computer program product (300) for servicing a reagent dispensing device (104), according to an example of the principles described herein. The computer program product may include computer readable storage medium. The computer readable storage medium may include computer usable program code embodied therewith. The computer usable program code, when executed by a processor, identifies, with a service identification module (301), a service parameter of at least one reagent dispensing device (104) within a reagent dispensing system (104). the service parameter may include any parameter that indicates that the reagent dispensing device (104) is due for at least one servicing process to be performed. For example, the service parameter may be based on a volume of reagent dispensed by the reagent dispensing device (104) since its last servicing process, an amount of time since the reagent dispensing device (104) was last serviced, the type of reagent contained within the reagent dispensing device (104), the movement of the reagent dispensing device (104) relative to the service module, the movement of the reagent dispensing device (104) from an in-line position to an off-line position or visa versa, the movement of the service module from an in-line position to an off-line position or visa versa, other service parameters, or combinations thereof.

In response to the service parameter being met, the computer usable program code, when executed by a processor, may initiate a servicing process of the reagent dispensing device (104) using a service module (130) integrated with the at least one reagent dispensing device (104) using a service initiation module (302). In one example, the processing device (414) and the storage device (415) may be used to set the service parameters, detect when the service parameters have been met, and initiate the servicing process by instructing the reagent module (103) or its reagent ejection devices (104) and the service module (130) to interface with one another in order to utilize the service devices (131) of the service module (130).

In one example, the service module (130) moves relative to the at least one reagent ejection device during the servicing process. In one example, the service module (130) may move with the at least one reagent ejection device (104) between the in-line position and the off-line position.

In one example, the at least one reagent dispensing device (104) may include a plurality of reagent dispensing devices (104). In this example, the plurality of the reagent ejection devices (104) may be integrated with the service module (130) within the integrated cartridge service station (200) of the reagent dispensing system (100), and initiating the servicing process may include servicing a plurality of the reagent ejection devices (104) integrated with the service module (130). The service module (130) of the integrated cartridge service station (200) may include a number of service devices (131). In this example, the service devices (131) may include, for example, a capping device, a wiping device, a spittoon device, or combinations thereof.

FIG. 4 is a block diagram of a reagent dispensing system (400), according to another example of the principles described herein. The reagent dispensing system (400) may include a number of elements including the reagent dispensing system (100), the integrated cartridge service station (200), and the computer program product (300), and their respective elements described in connection with FIGS. 1 through 3. Therefore, similarly-numbered elements included in FIGS. 1 through 3 and described in connection with FIGS. 1 through 3 designate similar elements within the reagent dispensing system (400) of FIG. 4.

As depicted in FIG. 4, a reagent module (103) is located within a reagent deposition area (402) of the reagent dispensing system (400) and is considered to be in an in-line position to dispense reagent (105) onto a number of substrates (450). In this manner, the reagent modules (103) may be physically coupled to the reagent dispensing system (400) and be seated within the reagent deposition area (402) in order to dispense reagent (105) onto the substrates (450).

The reagent dispensing system (400) may include a substrate conveyance system (401) such as; for example; a conveyor belt that moves a number of substrates (450) under the reagent deposition area (402) of the reagent dispensing system (400). However; any other type of conveyance system may be used such as, for example, mechanical stages that move in and out of the reagent deposition area (402), rolls or reels of flexible material that moves underneath the reagent dispensing devices (104) within the reagent modules (103), or other conveyance systems.

The direction of travel of the substrate conveyance system (401) is indicated by arrows (470). In one example, the substrate conveyance system (401) may move in either a positive or negative x-direction.

The reagent dispensing system (400) in the example of FIG. 4 includes a number of different reagent modules (103-1, 103-2, 103-3, collectively referred to herein as 103) that include differing architectures or form factors that allow them to dispense their respective volumes. For example, the reagent module (103-2) located within the reagent deposition area (402) includes four digitally addressable fluid ejection devices (408-1, 408-2, 408-3, 408-4, collectively referred to herein as 408). In one example, the four digitally addressable fluid ejection devices (408) may each include a volume of reagent (105). The reagent module (103-2) including the digitally addressable fluid ejection devices (408) may dispense an average or mid-range amount of reagent (105), and may be used for dispensing reagents that are dispensed at an average or mid-range frequency.

Other reagent modules (103-1, 103-2, 103-3) may be stored or placed off-line, and may be exchangeable with the in-line reagent module (103-2). Other architectures or form factors of reagent modules (103) may be included within the reagent dispensing system (400). Another architecture or form factor of reagent modules (103) may include a reagent module (103-1) that includes a cassette device (405), As described herein, the cassette device (405) may dispense between approximately 0.1 picoliters (pL) and 0.1 microliters (μL) as the first range of volumes of a reagent. The first range of volumes is less than the volumes that may be dispensed using the digitally addressable fluid ejection devices (104-2). The cassette device (405) may include, for example, a T8+ or D4+ dispensing cassette produced and distributed by HP, Inc, With these types of cassettes, a relatively small amount of reagent may be dispensed at a given time using a dispensing die that is capable of dispensing these relatively small volumes of fluid. The cassette device (405) may be used to dispense volumes of fluid that are less frequently dispensed relative to other reagents, are negatively susceptible to environmental conditions, are expensive to inventory, are mixed immediately before use, have a relatively short shelf life, have other properties that lend their use to relatively smaller volumes, or combinations thereof.

Another architecture or form factor of reagent modules (103) may include a reagent module (103-3) that includes a bulk reagent dispensing device (406). The bulk reagent dispensing device (406) may be fluidically coupled to a bulk reagent source (407) to provide the bulk reagent dispensing device (406) with ample reagent to dispense. The reagent module (103-3) including the bulk reagent dispensing device (406) may dispense a bulk or high-range amount of reagent (105), and may be used for dispensing reagents that are dispensed at above average frequencies.

Thus, the cassette device (405) of the reagent module (103-1) may dispense a first range of volumes. The digitally addressable fluid ejection devices (408) of the reagent module (103-2) may dispense a second range of volumes where the second range of volumes may be more voluminous relative to the first range of volumes. The bulk reagent dispensing device (406) of the reagent module (103-3) may dispense a third range of volumes where the third range of volumes may be more voluminous relative to the second range of volumes. Further, the cassette device (405) of the reagent module (103-1) may be utilized in dispensing reagents that are rarely or less-frequently dispensed. The digitally addressable fluid ejection devices (408) of the reagent module (103-2) may be utilized in dispensing reagents that are dispensed at an average frequency or at least more frequently than those reagents dispensed by the cassette device (405) of the reagent module (103-1). The bulk reagent dispensing device (406) of the reagent module (103-3) may be utilized in dispensing reagents that are very frequently used or at least more frequently used then those reagents dispensed by the digitally addressable fluid ejection devices (408) of the reagent module (103-2).

As depicted in FIG. 4, a number of exchange paths (410) depicted as dashed lines indicate a path on which an off-line reagent module (103) may take when being switched with an in-line module (103). In this example, an automated storage and retrieval system (ASRS) (420) may be used to transport the reagent modules (103) and their respective integrated cartridge service station (200) to and from the reagent deposition area (402). The ASRS (420) may include any number of conveyor systems, lift systems, robotic arms, other ASRS systems, and combinations thereof. In another example, a technician may manually exchange the reagent modules (103).

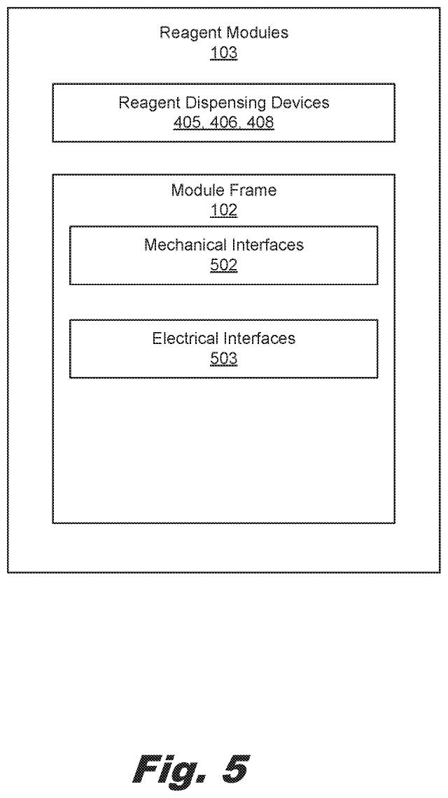

With continued reference to FIG. 4, FIG. 5 is a block diagram of a reagent module (103), according to an example of the principles described herein. When a reagent module (103) is placed in the reagent deposition area (402), a number of mechanical (411) and electrical (412) interfaces within the reagent dispensing system (400) and located at the reagent deposition area (402) including those provided by the module frame (102) interface with mating mechanical (502) and electrical (503) interfaces on the reagent modules (103). In this manner, the reagent modules (103) may be physically coupled to the reagent dispensing system (400) and be seated within the reagent deposition area (402) in order to dispense reagent (105) onto the substrates (450).

Further, in this physically coupled state, a number of electrical interfaces (503) located on the reagent modules (103) electrically interface with the electrical interfaces (412) located in the reagent deposition area (402) of the reagent dispensing system (400). This allows the reagent dispensing system (400) to send instructions in the form of signals to the modules (103) that cause the various reagent dispensing devices (405, 406, 408) to dispense their respective reagents (105) onto the substrates (450).

A processing device (414) and a data storage device (415) may be included in the reagent dispensing system (400) to instruct and store data about the reagent modules (103) and their respective reagent dispensing devices (405, 406, 408), and the integrated cartridge service station (200) with its service module (130) and respective service devices (131). The processing device (414) may provide signals to the reagent dispensing devices (405, 406, 408) to instruct the reagent dispensing devices (405, 406, 408) to dispense their respective reagents (105) onto the substrates (450). Further, the processing device (414) may instruct the ASRS (420) to exchange the in-line reagent module (103) with an off-line reagent module (103) in order to dispense a different reagent or volume of reagent. Still further, the processing device (414) may receive data from the ASRS (420) regarding the position (e.g., in-line or off-line positions) of the reagent module (103) and their integrated cartridge service station (200), store that information, and use it in connection with the ASRS (420) exchange the in-line reagent module (103) with an off-line reagent module (103).

The processing device (414) may further provide instructions to the conveyance system (401) as to speed and direction in moving the substrates (450) within the reagent deposition area (402) and under the reagent modules (103). Even still further, the processing device (414) may instruct the integrated cartridge service station (200) to service the reagent dispensing devices (104), digitally addressable fluid ejection devices (408), and the different reagent modules (103). The processing device (414) may instruct the integrated cartridge service station (200) to service the reagent dispensing devices (104), digitally addressable fluid ejection devices (408), and the different reagent modules (103) at any time or position including before deposition of a number of reagents, after deposition of a number of reagents, while the reagent module (103) is in an in-line position, while the reagent module (103) is in an off-line position, other times or positions, or combinations thereof. Further, the processing device (414) may instruct the integrated cartridge service station (200) to service the reagent dispensing devices (104), digitally addressable fluid ejection devices (408), and the different reagent modules (103) from these positions and activate a servicing process in these positions.

The data storage device (415) may include various types of memory modules, including volatile and nonvolatile memory. For example, the data storage device (415) of the present example may include Random Access Memory (RAM), Read Only Memory (ROM), and Hard Disk Drive (HDD) memory. Many other types of memory may also be utilized, and the present specification contemplates the use of many varying type(s) of memory in the data storage device (415) as may suit a particular application of the principles described herein. In certain examples, different types of memory in the data storage device (415) may be used for different data storage needs. For example, in certain examples the processor (414) may boot from Read Only Memory (ROM), maintain nonvolatile storage in the Hard Disk Drive (HDD) memory, and execute program code stored in Random Access Memory (RAM). The data storage device (415) may comprise a computer readable medium, a computer readable storage medium, or a non-transitory computer readable medium, among others. For example, the data storage device (415) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

Although only one reagent deposition area (402) is depicted in the reagent dispensing system (400) as a station at which the reagent modules (103) may dispense their respective reagents, the reagent dispensing system (400) may include a plurality of stations located along the substrate conveyance system (401). Each of the plurality of stations including a reagent deposition area (402) located along the substrate conveyance system (401) may include the mechanical (411) and electrical (412) interfaces to interface with the reagent modules (103).

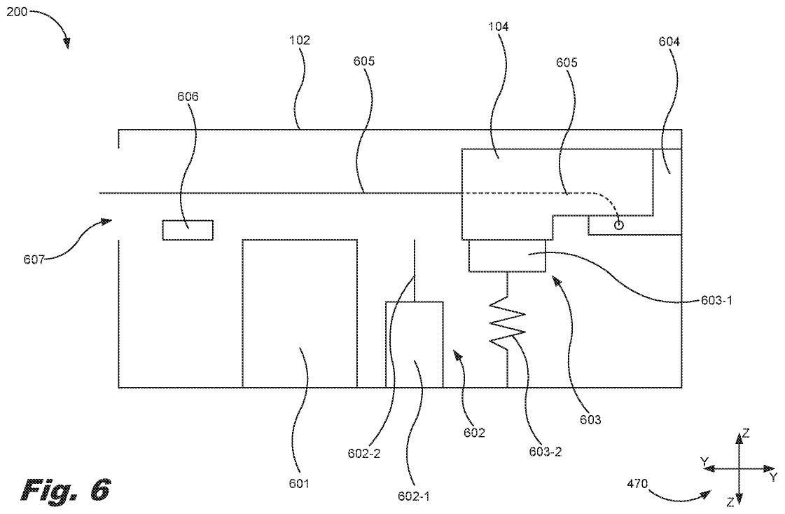

FIG. 6 is a diagram of an integrated cartridge service station (200), according to an example of the principles described herein. FIG. 6, depicts a single reagent dispensing device (104) within the integrated cartridge service station (200). However, any number of reagent dispensing devices (104) may be included within the integrated cartridge service station (200). Further, in the example of FIG. 6, the module frame (102) of the reagent module (103) serves as an outer housing for the integrated cartridge service station (200). However, in another example, the module frame (102) may be entirely separate from the integrated cartridge service station (200) and contained within the integrated cartridge service station (200).

The integrated cartridge service station (200) may include a spittoon (601). The spittoon (601) may be any vessel into which the reagent dispensing devices (104) may spit reagent (105). A “spitting” process is an action taken by the processor (414) instructing at least one of the reagent dispensing devices (104) to purge its reagent ejection elements such as its nozzles by sending it a sequence of fire pulses, possibly of greater energy than the normal firing pulse. This serves to ensure that the reagent (105) contained in the nozzles does not dry, causing a blockage of dry reagent, which stops the nozzle from firing correctly. Spitting processes also help to clear already blocked, or partially blocked nozzles, which may be caused by fibers or dried reagent, for example.

The integrated cartridge service station (200) may also include a wiper (602). The wiper (602) may include a base (602-1) supporting a blade (602-2). Servicing the reagent dispensing devices (104) may also include a wiping process. The wiping process may be achieved by wiping off or cleaning the reagent dispensing devices (104) of the reagent module (103) using the blade (602-2) of the wiper (602). As the reagent dispensing device (104) moves past the wiper (602), the blade (602-2) of the wiper (602) comes into contact with, for example, a nozzles plate or other structure from which reagent is dispensed. The wiping process may be executed before or after the reagent is deposited by the reagent dispensing devices (104) in order to allow the reagent dispensing devices (104) to properly dispense the reagent (105).

The integrated cartridge service station (200) may also include a capping module (603) to seal a number of nozzles of a number of reagent dispensing devices (104) within the reagent module (103) from ambient atmosphere. The capping module (603) may include a capping seal (603-1) coupled to a spring device (603-2). The spring device (603-2) may be any device that applies a biasing force to the capping seal (603-1) in the positive z-direction toward the reagent dispensing device (104) to cap a number of nozzles of the reagent dispensing devices (104).

In one example, the spring device (603-2) may be selectively activated such that when the reagent dispensing devices (104) is seated within a mechanical interface (604) of the integrated cartridge service station (200) the spring device (603-2) may bias the capping seal (603-1) toward the reagent dispensing devices (104). In one example, the force of the capping module (603) against the reagent dispensing device (104) may be defined and modulated by the spring device (603-2). In one example, the movement of the capping module (603) from an engaged position to a disengaged position and visa versa may be defined by a travel path of the reagent dispensing device (104) from an off-line position to an on-line position and visa versa. Further, in one example, the movement of the capping module (603) from an engaged position to a disengaged position and visa versa may be defined by the orientation of the capping seal (603-1) relative to a nozzle plate or nozzles of the reagent dispensing device (104). In one example, an electrical interconnect may be present between the spring device (603-2) of the capping module (603) and the reagent dispensing system (100, 400) such that the processing device (414) may control the activation of the spring device (603-2) to decap or cap the reagent dispensing device (104).

A mechanical interface (604) of the integrated cartridge service station (200) provides for a place for the reagent dispensing device (104) to be seated when the reagent dispensing device (104) is not in a position to dispense reagent, but is in an off-line position within the integrated cartridge service station (200). A rail system (605) may be included within the integrated cartridge service station (200) to allow the reagent dispensing device (104) to travel from the seated position when coupled to the mechanical interface (604) to an in-line position. The rail system (605) may include, for example, a number of pins to couple the reagent dispensing device (104) to a rail, and a number of gears and cables coupled to a drive motor to move the reagent dispensing device (104) to move the reagent dispensing device (104) along the rail.

The rail system (605) may move the reagent dispensing device (104) to an in-line position, and seated on an electrical and mechanical interface (606). The interface (606) provides the reagent dispensing device (104) with physical alignment and data for the reagent dispensing device (104) to dispense reagent onto a substrate.

As the reagent dispensing device (104) moves to an in-line position for dispensing the reagent, the capping module (603) may be deactivated such that the spring device (603-2) lowers the capping seal (603-1) and causes the capping seal (603-1) to disengage with, for example, a nozzle plate or a number of nozzles of the reagent dispensing device (104). As the reagent dispensing device (104) moves to the in-line position to seat with the interface (606), a nozzle plate or nozzles of the reagent dispensing device (104) comes into contact with the blade (602-2) of the wiper (602), and is wiped. Further, the reagent dispensing device (104) moves past the spittoon (601). The integrated cartridge service station (200) may instruct the reagent dispensing device (104) to perform a spit operation when the reagent dispensing device (104) is located above the spittoon (601).

An aperture (607) may be defined in the integrated cartridge service station (200) to allow the reagent dispensing device (104) to protrude from the integrated cartridge service station (200) to the exterior of the integrated cartridge service station (200) and dispense the reagent (105) contained therein. In one example, the reagent dispensing device (104) protrudes from the integrated cartridge service station (200) when seated on the interface (606), In this manner, the reagent dispensing device (104) is able to be autonomously removed from the integrated cartridge service station (200) in order to dispense reagents onto the dispersion surface (FIG. 4, 401).

With the spittoon (601), the wiper (602), and the capping module (603), the reagent dispensing device (104) may be serviced before deposition of a number of reagents, after deposition of a number of reagents, while the reagent module (103) is moved into an in-line position, while the reagent module (103) is moved into an off-line position, other times or positions, or combinations thereof. Further, other service devices may be included in the integrated cartridge service station (200).

Aspects of the present systems and methods are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to the processing device (414), such that the computer usable program code, when executed via, for example, the processing device (414) of the reagent dispensing system (100, 400) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe an integrated cartridge service station that may include a reagent module comprising at least one reagent ejection device, and a service module integrated with the reagent module. The service module may include at least one service device. The reagent module and the service module are movable with respect to one another within a reagent dispensing system, and the at least one reagent ejection device is movable between an in-line position and an off-line position within the reagent dispensing system.

This integrated cartridge service station provides a more effective end-user experience as it is easier to keep the reagents separate with minimal management by a technician or other end-user. The integration of the reagent dispensing devices with the service station reduce user errors and provide a superior end-user experience while allowing the system to function effectively.

The preceding description has been presented to illustrate and describe examples of the principles described. This description is not intended to be exhaustive or to limit these principles to any precise form disclosed. Many modifications and variations are possible in light of the above teaching.

What is claimed is:

1. A reagent dispensing system, comprising:
at least one reagent module comprising at least one reagent dispensing device to dispense a number of reagents on a substrate;
a module frame electrically and mechanically coupling the reagent dispensing device to the reagent dispersing system; and
a service module integrated with the at least one reagent ejection device, the service module comprising at least one service device,
wherein the at least one reagent ejection device and the integrated service module are movable with respect to one another, the reagent module being movable between an in-line position and an off-line position within the reagent dispensing system.

2. The reagent dispensing system of claim 1, wherein the at least one service device comprises a capping module to seal a number of nozzles of the at least one reagent ejection device from ambient atmosphere.

3. The reagent dispensing system of claim 1, wherein the at least one service device comprises a wiping module to wipe a nozzle plate of the at least one reagent ejection device.

4. The reagent dispensing system of claim 1, wherein the at least one service device comprises a spittoon to receive spat reagent from the at least one reagent ejection device.

5. The reagent dispensing system of claim 1, wherein the at least one reagent ejection device comprises:
a plurality of reagent ejection devices,
wherein the module frame couples the plurality of reagent ejection devices to one another, the coupled reagent ejection devices and module frame forming the reagent module, and
wherein the service module services each of the reagent ejection devices within the reagent module.

6. The reagent dispensing system of claim 1, wherein the service module services the at least one reagent dispensing device at an on-line position, at an off-line position, or a combination thereof.

7. The reagent dispensing system of claim 5, wherein the reagent ejection devices are grouped within the reagent module based on a probability of cross-contamination between the plurality of the reagent ejection devices, an expiration date of the reagents within the reagent dispensing cartridges, a frequency of use of the reagents within the reagent dispensing cartridges, a volume of use of the reagents within the reagent dispensing cartridges, or combinations thereof.

8. The reagent dispensing system of claim 1, wherein:
the at least one reagent ejection device comprises a plurality of reagent ejection devices,
the service module comprises a plurality of service devices, and
each of the reagent ejection devices are integrated with the service module.

9. An integrated cartridge service station comprising:
a reagent module comprising at least one reagent ejection device;
a service module integrated with the reagent module, the service module comprising at least one service device,
wherein the reagent module and the service module are movable with respect to one another within a reagent dispensing system, the at least one reagent ejection device movable between an in-line position and an off-line position within the reagent dispensing system.

10. The integrated cartridge service station of claim 9, wherein the at least one service device comprises a capping module to seal a number of nozzles of the at least one reagent ejection device from ambient atmosphere, a wiping module to wipe a nozzle plate of the at least one reagent ejection device, a spittoon to receive spat reagent from the at least one reagent ejection device, or combinations thereof.

11. The integrated cartridge service station of claim 10, wherein the spittoon comprises a disposable absorbent material.

12. The integrated cartridge service station of claim 10, wherein the wiping module and the spitting module comprises a disposable absorbent material.

13. A computer program product for servicing a reagent dispensing device, the computer program product comprising:
a computer readable storage medium comprising computer usable program code embodied therewith, the computer usable program code to, when executed by a processor:
identify a service parameter of at least one reagent dispensing device within a reagent dispensing system;
in response to the service parameter being met, initiate a servicing process of the reagent dispensing device using a service module integrated with the at least one reagent dispensing device,
wherein the service module moves relative to the at least one reagent ejection device during the servicing process.

14. The computer program product of claim 13, wherein:
the at least one reagent dispensing device comprises a plurality of reagent dispensing devices,
wherein the plurality of the reagent ejection devices are integrated with the service module, and
wherein initiating the servicing process comprises servicing a plurality of the reagent ejection devices integrated with the service module.

15. The computer program product of claim 13, wherein the integrated service module comprises a capping device, a wiping device, a spittoon device, or combinations thereof.
